(19) United States
(12) Patent Application Publication
(10) Pub. No.: US 2015/0078595 A1
(43) Pub. Date: Mar. 19, 2015

(54) AUDIO ACCESSIBILITY

(71) Applicant: SONY CORPORATION, Tokyo (JP)

(72) Inventors: Peter Rae Shintani, San Diego, NC (US); Frederick J. Zustak, Poway, CA (US)

(73) Assignee: SONY CORPORATION, Tokyo (JP)

(21) Appl. No.: 14/026,154

(22) Filed: Sep. 13, 2013

(51) Int. Cl. H04S 7/00

(52) U.S. Cl. CPC H04S 7/303
USPC 381/303

(57) ABSTRACT

An audio delivery method. An image of a listening area is captured and processed to locate a position of a listener in the room. A stored listener profile associated with the listener is retrieved and audio characteristics are established based on the listener's profile. A directional beam of audio is directed toward the listener's ears and the directional beam is adjusted to track movement of the listener. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

The Advanced Communications Services Act in the United States has requirements to address various disabilities, one of which is hearing. The Act requires that television equipment providers take steps to try to improve the presentation of audio to a person who has a hearing disability.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is an example of a television audio system consistent with certain embodiments of the present invention.

FIG. 2 is an example implementation of a listener profile consistent with certain embodiments of the present invention.

FIG. 3, which is made up of FIGS. 3A, 3B and 3C, depicts examples of the impact of a listener's head turning in a directional audio system consistent with certain embodiments of the present invention.

FIG. 4 is an example of a flow chart depicting a method of operation consistent with certain embodiments of the present invention.

FIG. 5 is an example of a flow chart of a method of adjustment of audio in a manner consistent with certain embodiments of the present invention.

FIG. 6 is an example of a block diagram representation of a directional audio system consistent with certain embodiments of the present invention.

FIG. 7 is an example of an arrangement for directing ultrasonic audio arrays toward a location in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or similar terms, as used herein, is defined as a sequence of instructions designed for execution on a computer system. A “program”, or “computer program”, may include a subroutine, a function, a procedure, an app, an object method, an object implementation, in an executable application, an applet, a servlet, a source code, an object code, a script, a program module, a shared library/dynamic load library and/or other sequence of instructions designed for execution on a computer system. As used herein, the term “television receiver device” or similar is intended to encompass any television receiver including a television set, a set-top box (STB), or other device configured to receive television programming. A “display” or similar can form part of a television device or a computer system capable of receiving content that includes audio. Devices consistent with the teachings herein can be instantiated into a STB, a standalone sound bar, or external add-on audio device, or a monitor having audio capability but no tuner as well as other implementations.

Reference throughout this document to “one embodiment”, “certain embodiments”, “an embodiment”, “an implementation”, “an example” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “audio characteristics” is to be interpreted to mean attributes that can be adjusted in an electronic audio signal including, but not limited to, volume, equalization, compression, room simulations, channel mix, etc.

As noted previously, the Advanced Communications Services Act in the United States has requirements to address various disabilities, one of which is hearing. The Act requires that television equipment providers take steps to try to improve the presentation of audio to a person who has a hearing disability.

It is noted that hearing disabilities vary greatly from person to person and often are asymmetrical. The hearing loss may be restricted to one ear, or may be more or less severe in one ear than the other. Also, the affected frequencies vary from person to person and even from ear to ear on the same person. Such hearing disabilities may present difficulties when multiple people with differing hearing abilities are in the same television viewing area. This can result in television audio being adjusted primarily to address the hearing of the person with the poorest hearing, which may be uncomfortably loud for other listeners.

Audio signals can be made to be highly directional using ultrasonic techniques in which arrays of small ultrasonic transducers are used to send ultrasonic beams that are quite directional. This high level of directionality is primarily the result of the transducers being made to approximate the wavelength of the ultrasonic signals transmitted. By sending two ultrasonic signals toward a listener's ear, audio can be encoded into the frequency differences between the two signals. As a result of non-linearities in the air and the ears, a mixing of the two ultrasonic signals occurs resulting in sum and difference signals. The difference signals represent the originally encoded audio and can be heard by the listener. By directing two such sets of beams toward a listener's left and right ears, stereo audio programming can be achieved.

This mechanism can be utilized advantageously to provide improvement in the hearing of audio in those who are hearing impaired. It is common, for example when watching television (TV), for a hearing impaired person to require high volume levels to be able to enjoy the television programming Unfortunately, this can be at the expense of other listeners who are not hearing impaired and would prefer a lower volume level.

Accordingly, delivery of the audio to a listener can be tailored to the individual's hearing characteristics, and in conjunction with ultrasonic delivery, the individualized audio can be directed to an individual. Furthermore, the individual can be identified by a camera, using image recognition and then the tailored sound can be directed to the identified individual. Aiming of the sound can be done in several ways. A phased array of transducers can be used, but there are limitations with this method, such as the granularly (angular) of the directivity, and also the number of listeners that can be targeted simultaneously.

The preferred method is to use ultrasonic delivery of the individualized sound as discussed above. Sound is frequency shifted to the ultrasonic range, such as approximately 40 kHz. The ultrasonic sound is then beat with another ultrasonic sound, which results in the sum, difference and fundamentals. Only the difference signal is heard by the listener. Since the wavelength of the ultrasonic sound is an appreciable portion of the dimension of the transducer, this results in a very directional delivery of the sound. This allows directing sound to an individual recipient.

In order to aim the sound, one technique is to have several adjustable zones, which may be either fixed or pre-set. A listener typically sits in discrete fixed locations typically dictated by the relatively fixed location of the chairs or sofa's in a room. Hence once set, only the listener will have to be identified and his location amongst the pre-set locations needs to be determined. The identity of the listener could be simplified if the user manually identified himself, or could be more sophisticated as using such techniques as RFID, Bluetooth, possession of the remote control or one of many remote controls, possession of a cellular phone, which is identifiable, etc. In the preferred implementation, a camera or other image capture device is used to locate and identify listeners using facial recognition and stored listener profiles, and to spatially characterize each listener.

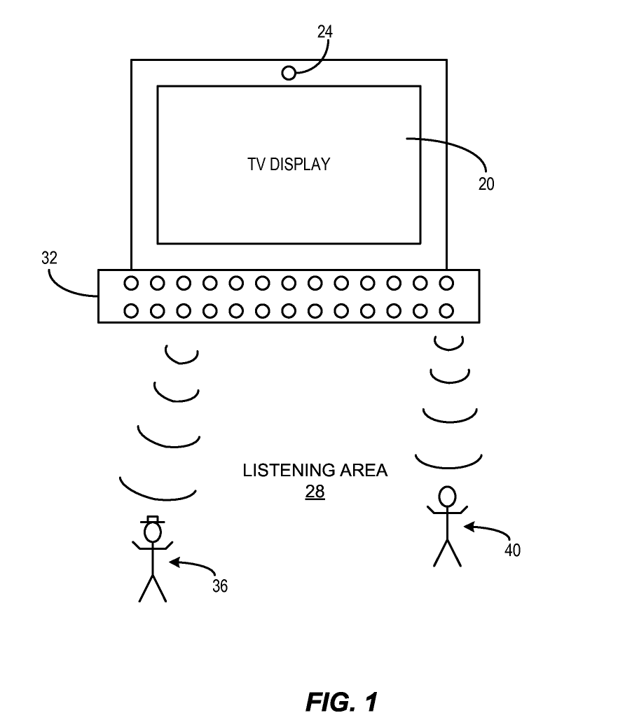

Turning now to FIG. 1, consider a non-limiting example television system implementation consistent with certain embodiments in which ultrasonic audio is used to isolate the audio among several listeners. In this illustration, a display 20 or other device such as a television receiver device (STB, external audio processing device, etc.) has an integrated camera 24 that images a listening area 28. An audio system associated with or integral to the display 20 utilizes an array 32 of ultrasonic transducers that can be utilized to direct targeted directional beams of audio using the ultrasonic techniques discussed above to one or more listeners such as listener 36 and listener 40. In certain implementations, these listeners 36 and 40 may be frequent viewers of the television set and hence are frequently present in the listening area 28.

In order to customize the audio experience of each of the listeners, a profile can be established for each listener, and a default or guest profile can be provided for unrecognized listeners. The camera 24, by imaging the listening area, can be used to provide images that upon analysis can determine 1) the location of each listener, 2) the location of the head and ears of each listener, 3) recognize each registered and profiled listener, or assign the listener to be a guest, 4) to track movements of the listeners, 5) to note movements that are of significance to the listening experience in the listeners, and 6) to tailor the audio program to the listener's preferences or hearing abilities as set forth in the listener's profile. In this manner, if listener 36 has normal hearing and listener 40 has degraded hearing abilities, each can be treated individually according to their needs and preferences with minimal impact on the other. In another embodiment, a preferred language may be included in the profile, and thus multiple languages may be provided. Various audio language sub-channels may be used to accommodate listeners preferring a language other than that provided in the main audio channel, or the default language indicated during setup. In another embodiment, a word substitution engine could selectively replace objectionable words or phrases for those specific listeners identified and associated with a parental control limitation or restriction.

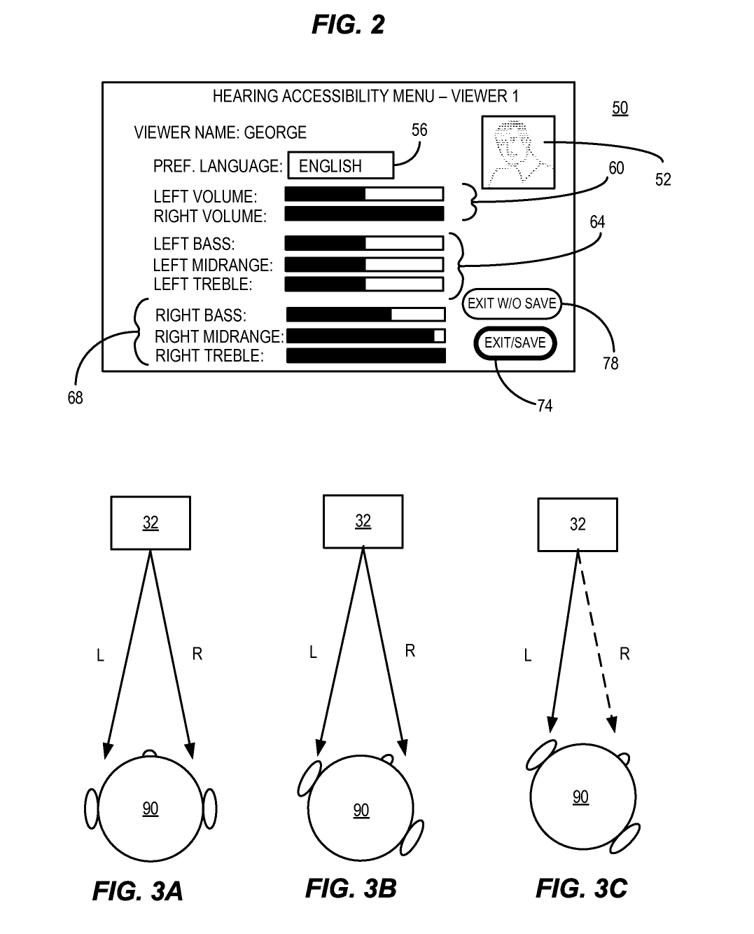

By way of example, and not limitation, consider an implementation in a television system and the profile screen 50 of a listener named “George” as depicted in FIG. 2. In this example profile screen (e.g., called from a television's menu system), the listener can provide an image 52 for reference and can select a preferred language at 56 which can be used to select from available audio language sub-channels where possible. It is further noted that the listener profile may be a part of a larger user profile that includes other preferences, characteristics and/or restrictions not explicitly shown. The television's camera 24, when capturing an image of the listening area can use this image as a reference for facial recognition in order to retrieve George's audio characteristics from the profile 50. In this example, George's hearing in the right ear is poor compared to the left ear, and this is reflected in the volume settings 60 in which the right ear volume is at full and the left ear volume is at about half. Additionally, at 64 is appears that the left ear has a balanced ability to hear low, middle and high frequencies as compared to the right ear which has difficulties in hearing higher frequencies as shown in 68. In this example, a person with normal hearing might be presumed to have frequency equalization near flat with volume at a lower level (e.g., about 25%).

Using this profile as a template, the audio system can beam a specialized audio signal to George in which the right channel volume is quite high and the left volume is higher than normal. Additionally, the audio in the right channel will be adjusted to provide more volume on middle and high frequencies than the low frequencies. This profile can be established experimentally with the assistance of the audio system or based upon the listener's preference. In one embodiment, an audio setup would guide the user in setting up a personal profile by playing testing the listener's hearing and modifying the audio characteristics in accordance with listener responses to an audio setup protocol. In examples of such implementations, test tones can be generated and the user can respond to determine at what level a particular user can hear a particular range of frequencies. In so doing, the user can either manually adjust the equalization to improve his or her ability to hear or the audio system can deduce an appropriate equalization for use in the profile.

In another example implementation, words or phrases can be displayed on the display while being played audibly (e.g., once in each channel) and the user queried as to the ability to understand the spoken words or phrases that are displayed. For example, since most hearing problems start with degradation of the ability to hear high frequency components. Hence words such as “spoon”, “ship”, “thicket”, etc. with substantial high frequency content can be played and the user can indicate a particular Q, equalization, filtering and balance that results in best intelligibility, and/or equality of hearing on right and left sides. The system can run each user through a training process in which filter characteristics are systematically varied and each user can assist in optimizing the ability to hear speech with greatest intelligibility. Once the data are established for the profile, the profile can be saved using button 74 or as part of an automated setup process to exit the profile and save or the listener can exit without saving by using button 78 which reverts the profile back to prior settings or no profile if none was previously established.

In this example, it is presumed that the audio program will be beamed to the listener in stereo, but this is not to be considered limiting since the audio could be beamed in monophonic form equally well with lesser requirements on the directivity and accuracy of the audio beam. Moreover, although the audio can be beamed to left and right ears, there is no requirement that there be no overlapping in the ultrasonic audio beams.

It is noted that when surround sound is delivered in stereo in a conventional stereo audio system, the stereo mix is often a mix that is derived from larger number of channels in a multi-channel audio program. For example, a 5.1 channel audio system has a center channel, a left front channel, a right front channel, a rear left channel, a rear right channel and a subwoofer channel. In such multi-channel audio mixes, it is common that the center channel carries the bulk of the dialog (speech) in the television program or movie being watched. Similarly, the low frequencies are handled in the subwoofer channel, etc. When this is mixed to stereo, the center channel dialog is commonly split among the left and right channels. Since only one or two channels are most commonly used for television and other audio reproduction, the mix-down of audio signals from the multi-channel audio to a lesser number of channels can be adjusted to achieve a more desirable listening experience for those with hearing impairments.

For example, if the listener has an impaired ability to recognize speech in the presence of other sounds, it may be advantage to provide a higher level of the center channel mix to that listener based on the listener's profile. Hence, an audio delivery method consistent with certain embodiments utilizes a programmed processor to retrieve and read a stored listener profile to ascertain audio characteristic settings associated with a listener; and at an audio mixer, the programmed processor can adjust a mixing of channels of a multiple channel audio program to a reduced number of channels based upon the stored listener profile so as to improve the listening experience of the listener.

Referring now to FIG. 3, which is made up of FIGS. 3A, 3B and 3C, upon consideration of the present teachings it will be appreciated that when the audio is sent to the listener with a directional beam, other issues may arise. In FIG. 3A, when a listener 90 is positioned so that both ears are readily targeted directly by the left and right audio beams (shown as L and R), the listener will hear stereo audio in the manner intended. But, as the listener 90 rotates his head as shown in FIG. 3B, the audio program for the left ear will become more prominent than that of the right ear. Taking the example further, consider FIG. 3C in which the right ear is fully obstructed by the head (as indicated by the dashed line representing the right ear beam) while the left ear is easily targeted by the left ear beam. In such a situation, the directionality of the beams and the stereo separation of the left and right audio may work to the disadvantage of the listener 90. In this case, it is generally best when audio is lost or diminished by the motion of the listener's head, that a television program or movie dialog not be lost. Accordingly, in a manner consistent with the teachings herein, as the target listener moves (particularly when moving his head), these movements are tracked by the camera 24 taking continuous images of the listener. When the system detects that a movement will disrupt the listener's hearing experience, the mix-down of the original multi-channel program material can be adapted—or the mix of the stereo audio can be adjusted.

By way of example and not limitation, when the head position is detected to move from that shown in FIG. 3A to that of FIG. 3C, the mix can be automatically manipulated under programmed processor control to shift the right channel audio to the left channel. In another embodiment, with the same head movement, the mix can be automatically manipulated under programmed processor control to shift the center channel mix to the left channel so that the listener is most likely to not lose the dialog. In each case, as the audio mix is adjusted by the processor, the listener's hearing profile is referenced so that in the above example if listener 90 is George, if right channel information is shifted to the left channel, the volume can be reduced in accord with the differences in overall hearing between left and right ears, and the frequency equalization of the audio sent to the left ear that would normally be in the right ear is similarly adjusted to, for example, reduce the high frequency content. In still other embodiments, the mix of the various channels may be manipulated to enhance the listener's experience. For example, if a person's hearing is such that speech intelligibility is poor in the left ear and good in the right ear, dialog can be mixed primarily to the right ear based upon the profile information. The mix can be manipulated by changing the mix-down from a larger number of channels or by simply shifting the mix between left and right to achieve a reduction in stereo separation (approaching or becoming monaural), or any other fashion that is desired. Many other variations will occur to those skilled in the art upon consideration of the present teachings.

It is also noted that when a person is having hearing difficulty, it is often a near automatic action of a listener with a hearing impairment to rotate his head so that the best ear is facing the source of audio. Accordingly, the present changing of mixing or other audio characteristics is consistent with an improvement that takes advantage of this common human reaction.

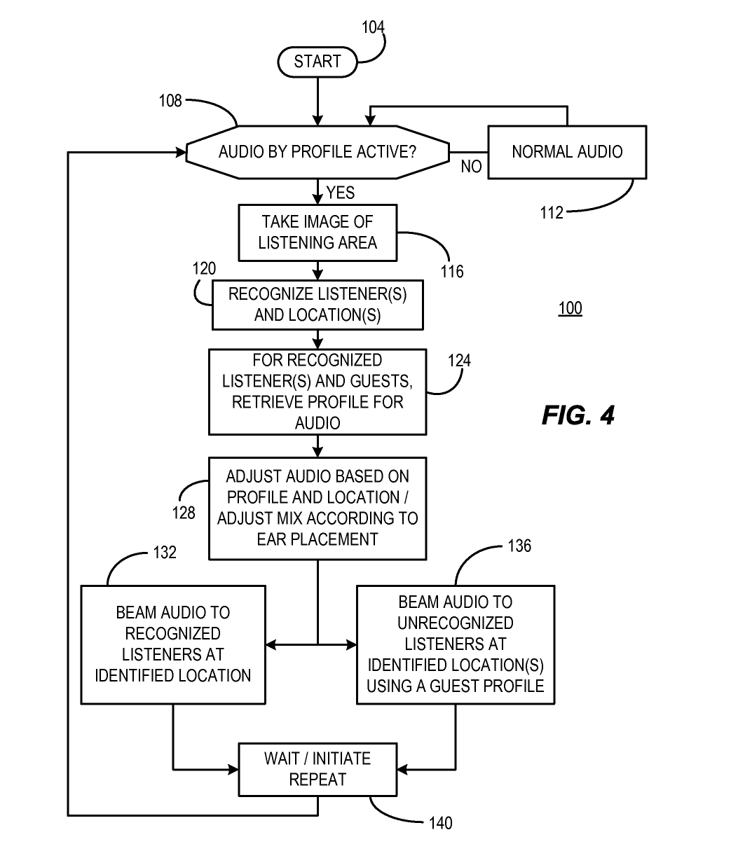

Referring now to FIG. 4, a flow chart 100 of one implementation example is depicted starting at 104. At 108, the audio system determines whether or not the system has been configured to use beaming of directional audio associated with listener profiles or not. If not, the system may revert to a more conventional audio system with conventional loudspeakers at 112. If so, one or more images are taken of the listening area at 116 and that image is analyzed at 120 to attempt to identify listeners and their locations using image analysis programs. In the image analysis, people are identified and then facial recognition algorithms are initiated in an effort to identify people who have stored profiles with the listeners' audio characteristics. For the recognized listeners, their profiles are retrieved from a profile database and for unrecognized listeners, a default or guest profile is retrieved at 124. The audio characteristics are then adjusted based upon the listener's profile and their location at 128. The mix and other audio characteristics may be adjusted according to their ear placement as discussed previously.

Once the audio profiles are loaded, the audio is directionally beamed to the recognized listeners at 132 at their physical location within the listening area. Similarly, unrecognized listeners simultaneously receive directional beams of audio at their physical location within the listening area using a default or guest profile at 136. In order to maintain a continuous tracking of the physical location of the listeners and also to monitor their head position if that is utilized in the manner discussed above, the process is continuously updated by initiating a repeating of the process at 140 where the process proceeds back to 108. While not explicitly depicted in this example process 100, block 124 can be skipped if no new listeners enter the listening area.

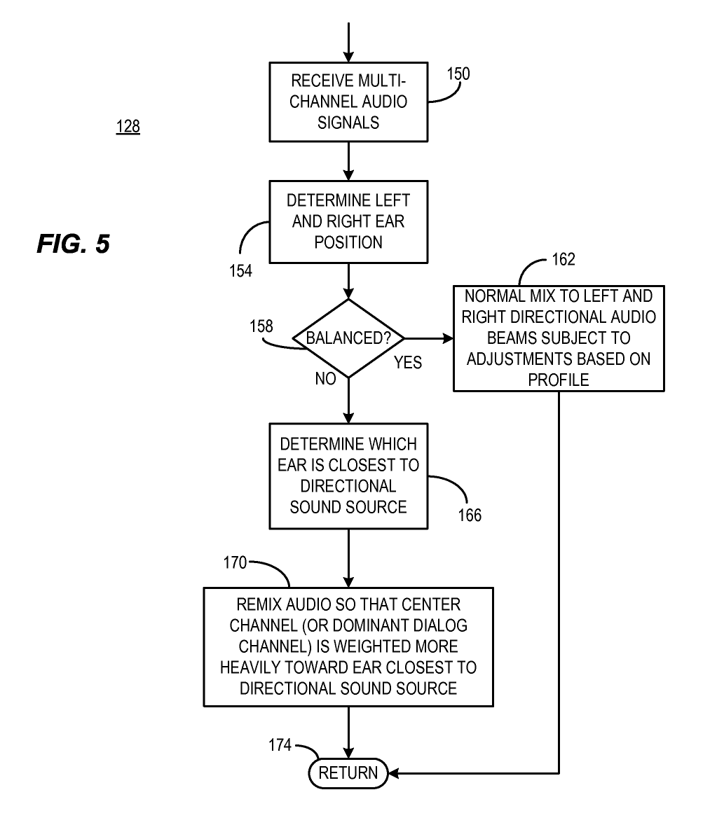

Function 128 of process 100 can be implemented in a variety of ways including the example process depicted as 128 of FIG. 5. In this example process implementation, multi-channel audio (e.g., stereo, 5.1 surround, 7.1 surround, etc.) is received at 150. The left and right ear positions are located for each listener at 154. If the left and right ears are both easily targeted (balanced) as in FIG. 3 at 158, a normal mix of channels subject to the particular listener's profile are presented assigned to the listener's beam of audio channels at 162. But, if the listener's head is positioned such that the system determines that beaming to one ear or the other will be degraded, the system determines which ear is closest to the directional sound source at 166. The audio is then remixed at 170. In this example, the remix places a heavier weighting of a channel containing dialog (e.g., center channel) to the ear closest to the directional audio source. In other implementations, if both ears can still at least partially receive the sound beam, the volume of the audio to the ear farthest from the directional sound source can be increased to provide a continuous stereo experience until the system deems that beaming to the ear farthest from the directional sound source cannot be relied upon to properly receive the sound beam. In this case, the mix can be converted to monaural, or otherwise the dialog channel shifted to the ear closest to the directional sound source, or other appropriate mixing and re-equalizing can be implemented. In any case, from both 162 and 170, for each listener, the process returns at 174 to complete process 128. Many other variations will occur to those skilled in the art upon consideration of the present teachings.

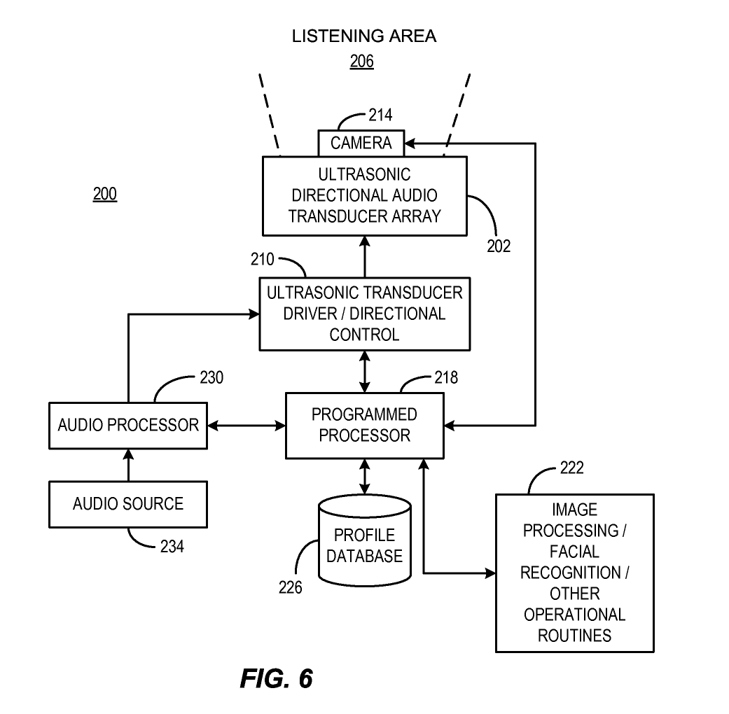

An example system consistent with certain implementations is depicted as system 200 of FIG. 6. An array of directional audio transducers such as ultrasonic transducers 202 are directed generally toward a listening area 206 and are driven by a transducer driver and directional control 210. Block 210 serves to drive the ultrasonic transducer array 202 in a manner that produces a directional beam of audio toward a listener in the manner previously discussed. Listeners are located and identified by use of camera 214 under control of a programmed processor 218 which is programmed to carry out image processing for identification of location and for facial recognition as previously discussed under program control from program instructions stored in a non-transitory storage medium and depicted as 222.

The captured images are processed as discussed previously to identify and locate people in the listening area 206. The facial recognition algorithm of 222 is then executed to compare the faces found with faces in the profile database 226. When a listener is identified in profile database 226, the programmed processor (or processors) 218 use the profile data to carry out a mixing and equalization function within audio processor 230 so that the audio from audio source 234 is adjusted to compensate for the hearing of the listener in accord with the listener's profile.

This process is continually updated so as to identify movements of the various listeners and maintain appropriate beam or beams of audio to each listener in the manner discussed above.

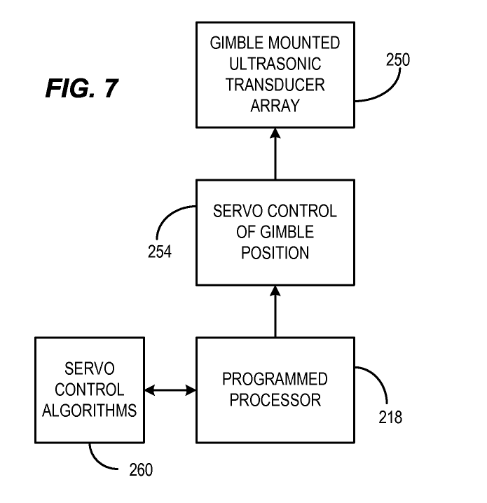

Direction of the beams of audio may be carried out in any operative manner. For example, as depicted in FIG. 7, a plurality of ultrasonic transducers arrays can be mounted on a gimbal mounting arrangement that permits at least horizontal rotation, but preferably permits two dimensional motions in both horizontal and vertical direction rotation so as to permit the ultrasonic transducer array 250 to target a wide range of locations within the listening area 206. The gimbal mounts are adjusted under control of programmed processor 218 running servo control algorithms to suitably target the listener(s) by driving the gimbal mounted ultrasonic transducer arrays 250 using servo controllers 254. Multiple such arrangements are provided so as to be able to target a number of listeners at any given time within listening area 206. Those skilled in the art will appreciate that other arrangements can also be provided in order to target the listeners with directional audio beams upon consideration of the present teachings.

Thus, in accord with certain implementations, an audio delivery method involves using an image capture device to capture an image of a listening area; at one or more programmed processors: processing the image to locate a position of a listener in the listening area, processing the image to identify a face of the listener in the listening area, processing the image to locate a position of the listener's ears, retrieving a stored listener profile associated with the identified face, adjusting one or more audio characteristics based upon the listener profile, and controlling a directional beam of audio to direct the directional beam of audio toward the listener's ears. An image capture device is used to capture a subsequent sequence of images of the listener, and at the one or more programmed processors: monitoring movement in position of the listener's ears in the listening area by analysis of the subsequent sequence of images, and adjusting the directional beam of audio in accordance with movements of the listener within the listening area.

In certain implementations, the directional beam of audio comprises a mix-down of a multi-channel audio program that includes a multiple channels. In certain implementations, adjusting the directional beam of audio includes changing a mixing of the multi-channel audio program. In certain implementations, the multi-channel audio program includes a center channel and where the mixing of the multiple channels comprises increasing an amplitude of the center channel program to an ear of the listener that is moved to a closest location to a source of the directional beams of audio. In certain implementations, the directional beams of audio comprise ultrasonic audio beams. In certain implementations, the image capture device comprises a camera integrated into a television receiver device. In certain implementations, the image capture device comprises a camera integrated into an electronic display device. In certain implementations, the controlling involves controlling servo motors that position gimbal mounted ultrasonic transducer arrays.

Another audio delivery method involves using an image capture device to capture an image of a listening area. At one or more programmed processors: the process proceeds by processing the image to locate a position of a listener in the listening area, processing the image to identify a face of the listener in the listening area, processing the image to locate a position of the listener's left and right ears, retrieving a stored listener profile associated with the identified face, adjusting one or more audio characteristics based upon the listener profile, and controlling left and right channel directional beams of audio to direct the left and right directional beams of audio toward the listener's left and right ears respectively; using the image capture device to capture a subsequent sequence of images of the listener. At the one or more programmed processors the process further involves: monitoring movement in position of the listener's ears in the listening area by analysis of the subsequent sequence of images, and adjusting a mixing of audio carried by the left and right directional beams of audio in accordance with movements of the listener's left and right ears within the listening area.

In certain implementations, the left and right directional beams of audio comprise a stereo mix-down of a multi-channel audio program that includes a center channel. In certain implementations, adjusting the mixing of audio comprises increasing an amplitude of the center channel program to either one of the right or left ears of the listener so as to increase amplitude of the center channel program for the one of the right or left ears of the listener that is moved to a closest location to a source of the directional beams of audio. In certain implementations, the directional beams of audio comprise ultrasonic audio beams. In certain implementations, the image capture device comprises a camera integrated into a television receiver device. In certain implementations, the image capture device comprises a camera integrated into an electronic display device. In certain implementations, the controlling comprises controlling servo motors that position gimbal mounted ultrasonic transducer arrays.

Another example of an audio delivery system has an image capture device configured to capture an image of a listening area. One or more programmed processors are programmed to: process the image to locate a position of a listener in the listening area, process the image to identify a face of the listener in the listening area, process the image to locate a position of the listener's ears, retrieve a stored listener profile associated with the identified face, adjust one or more audio characteristics based upon the listener profile, and control a directional beam of audio to direct the directional beam of audio toward the listener's ears. The image capture device is further configured to capture a subsequent sequence of images of the listener; and the one or more programmed processors are further programmed to: monitor movement in position of the listener's ears in the listening area by analysis of the subsequent sequence of images, and adjust the directional beam of audio in accordance with movements of the listener within the listening area.

In certain implementations, the directional beam of audio comprises a mix-down of a multi-channel audio program that includes a multiple channels. In certain implementations, adjusting the directional beam of audio comprises changing a mixing of the multi-channels audio program. In certain implementations, the multi-channel audio program includes a center channel and where the mixing of the multiple channels comprises increasing an amplitude of the center channel program to an ear of the listener that is moved to a closest location to a source of the directional beams of audio. In certain implementations, the directional beams of audio comprise ultrasonic audio beams. In certain implementations, the image capture device comprises a camera integrated into a television receiver device. In certain implementations, the image capture device comprises a camera integrated into an electronic display device. In certain implementations, at least one gimbal mounted ultrasonic transducer arrays, and where controlling and adjusting the directional beam of audio comprises controlling servo motors that position the gimbal mounted ultrasonic transducer array.

Another audio delivery system has an image capture device configured to capture an image of a listening area. One or more programmed processors are programmed to process the image to locate a position of a listener in the listening area, process the image with to identify a face of the listener in the listening area, process the image to locate a position of the listener's left and right ears, retrieve a stored listener profile associated with the identified face, adjust one or more audio characteristics based upon the listener profile, and control left and right channel directional beams of audio to direct the left and right directional beams of audio toward the listener's left and right ears respectively. The image capture device is further configured to capture a subsequent sequence of images of the listener; and the one or more programmed processors are further programmed to: monitor movement in position of the listener's ears in the listening area by analysis of the subsequent sequence of images, and adjust a mixing of audio carried by the left and right directional beams of audio in accordance with movements of the listener's left and right ears within the listening area.

In certain implementations, the left and right directional beams of audio comprise a stereo mix-down of a multi-channel audio program that includes a center channel. In certain implementations, adjusting the mixing of audio comprises increasing an amplitude of the center channel program to either one of the right or left ears of the listener so as to increase amplitude of the center channel program for the one of the right or left ears of the listener that is moved to a closest location to a source of the directional beams of audio. In certain implementations, the directional beams of audio comprise ultrasonic audio beams. In certain implementations, the image capture device comprises a camera integrated into a television receiver device. In certain implementations, the image capture device comprises a camera integrated into an electronic display device. In certain implementations, at least a pair of gimbal mounted ultrasonic transducer arrays, and where controlling and adjusting the directional beams of audio comprises controlling servo motors that position the gimbal mounted ultrasonic transducer arrays.

An audio delivery method consistent with certain implementations involves at a programmed processor, retrieving and reading a stored listener profile to ascertain audio characteristic settings associated with a listener; and at an audio mixer, the programmed processor adjusting a mixing of channels of a multiple channel audio program to an equal or reduced number of channels based upon the stored listener profile.

In certain implementations, the method further involves playing the equal or reduced number of channels to the listener. In certain implementations, the programmed processor further adjusts the mixing of the channels based upon a position of the listener.

In audio delivery method, an image of a listening area is captured and processed to locate a position of a listener in the room. A stored listener profile associated with the listener is retrieved and audio characteristics are established based on the listener's profile. A directional beam of audio is directed toward the listener's ears and the directional beam is adjusted to track movement of the listener.

Those skilled in the art will recognize, upon consideration of the above teachings, that certain of the above exemplary embodiments are based upon use of one or more programmed processors. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Certain example embodiments described herein, are or may be implemented using a programmed processor such as processor 218 executing programming instructions that are broadly described above in flow chart form that can be stored on any suitable non-transitory electronic or computer readable storage medium, where the term “non-transitory” as used herein is intended only to exclude propagating waves and not devices such as random access memory that loses information when power is removed or rewritable memory. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping, time outs, etc. can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. An audio delivery method, comprising:
using an image capture device to capture an image of a listening area;
at one or more programmed processors:
processing the image to locate a position of a listener in the listening area,
processing the image to identify a face of the listener in the listening area,
processing the image to locate a position of the listener's ears,
retrieving a stored listener profile associated with the identified face,
adjusting one or more audio characteristics based upon the listener profile, and
controlling a directional beam of audio to direct the directional beam of audio toward the listener's ears;
using the image capture device to capture a subsequent sequence of images of the listener; and
at the one or more programmed processors:
monitoring movement in position of the listener's ears in the listening area by analysis of the subsequent sequence of images, and
adjusting the directional beam of audio in accordance with movements of the listener within the listening area.

2. The method in accordance with claim 1, where the directional beam of audio comprises a mix-down of a multi-channel audio program that includes a multiple channels.

3. The method in accordance with claim 2, where adjusting the directional beam of audio comprises changing a mixing of the multi-channel audio program.

4. The method in accordance with claim 3, where the multi-channel audio program includes a center channel and where the mixing of the multiple channels comprises increasing an amplitude of the center channel program to an ear of the listener that is moved to a closest location to a source of the directional beams of audio.

5. The method in accordance with claim 1, where the directional beams of audio comprise ultrasonic audio beams.

6. The method in accordance with claim 1, where the image capture device comprises a camera integrated into a television receiver device.

7. The method in accordance with claim 1, where the image capture device comprises a camera integrated into an electronic display device.

8. The method in accordance with claim 1, where the controlling comprises controlling servo motors that position gimbal mounted ultrasonic transducer arrays.

9. An audio delivery method, comprising:
using an image capture device to capture an image of a listening area;
at one or more programmed processors:
processing the image to locate a position of a listener in the listening area,
processing the image to identify a face of the listener in the listening area,
processing the image to locate a position of the listener's left and right ears,
retrieving a stored listener profile associated with the identified face,
adjusting one or more audio characteristics based upon the listener profile, and
controlling left and right channel directional beams of audio to direct the left and right directional beams of audio toward the listener's left and right ears respectively;
using the image capture device to capture a subsequent sequence of images of the listener; and
at the one or more programmed processors:
monitoring movement in position of the listener's ears in the listening area by analysis of the subsequent sequence of images, and
adjusting a mixing of audio carried by the left and right directional beams of audio in accordance with movements of the listener's left and right ears within the listening area.

10. The method in accordance with claim 9, where the left and right directional beams of audio comprise a stereo mix-down of a multi-channel audio program that includes a center channel.

11. The method in accordance with claim 9, where adjusting the mixing of audio comprises increasing an amplitude of the center channel program to either one of the right or left ears of the listener so as to increase amplitude of the center channel program for the one of the right or left ears of the listener that is moved to a closest location to a source of the directional beams of audio.

12. The method in accordance with claim 9, where the directional beams of audio comprise ultrasonic audio beams.

13. The method in accordance with claim 9, where the image capture device comprises a camera integrated into a television receiver device.

14. The method in accordance with claim 9, where the image capture device comprises a camera integrated into an electronic display device.

15. The method in accordance with claim 9, where the controlling comprises controlling servo motors that position gimbal mounted ultrasonic transducer arrays.

16. An audio delivery system, comprising:
an image capture device configured to capture an image of a listening area;
one or more programmed processors programmed to:
process the image to locate a position of a listener in the listening area,
process the image to identify a face of the listener in the listening area,
process the image to locate a position of the listener's ears,
retrieve a stored listener profile associated with the identified face,
adjust one or more audio characteristics based upon the listener profile, and
control a directional beam of audio to direct the directional beam of audio toward the listener's ears;
the image capture device further being configured to capture a subsequent sequence of images of the listener; and
the one or more programmed processors being further programmed to:
monitor movement in position of the listener's ears in the listening area by analysis of the subsequent sequence of images, and
adjust the directional beam of audio in accordance with movements of the listener within the listening area.

17. The system in accordance with claim 16, where the directional beam of audio comprises a mix-down of a multi-channel audio program that includes a multiple channels.

18. The system in accordance with claim 17, where adjusting the directional beam of audio comprises changing a mixing of the multi-channels audio program.

19. The system in accordance with claim 18, where the multi-channel audio program includes a center channel and where the mixing of the multiple channels comprises increasing an amplitude of the center channel program to an ear of the listener that is moved to a closest location to a source of the directional beams of audio.

20. The system in accordance with claim 16, where the directional beams of audio comprise ultrasonic audio beams.

21. The system in accordance with claim 16, where the image capture device comprises a camera integrated into a television receiver device.

22. The system in accordance with claim 16, where the image capture device comprises a camera integrated into an electronic display device.

23. The system in accordance with claim 16, further comprising at least one gimbal mounted ultrasonic transducer arrays, and where controlling and adjusting the directional beam of audio comprises controlling servo motors that position the gimbal mounted ultrasonic transducer array.

24. An audio delivery system, comprising:
an image capture device configured to capture an image of a listening area;
one or more programmed processors programmed to:
process the image to locate a position of a listener in the listening area,
process the image with to identify a face of the listener in the listening area,
process the image to locate a position of the listener's left and right ears,
retrieve a stored listener profile associated with the identified face,
adjust one or more audio characteristics based upon the listener profile, and
control left and right channel directional beams of audio to direct the left and right directional beams of audio toward the listener's left and right ears respectively;
the image capture device further being configured to capture a subsequent sequence of images of the listener; and
the one or more programmed processors being further programmed to:
monitor movement in position of the listener's ears in the listening area by analysis of the subsequent sequence of images, and
adjust a mixing of audio carried by the left and right directional beams of audio in accordance with movements of the listener's left and right ears within the listening area.

25. The system in accordance with claim 24, where the left and right directional beams of audio comprise a stereo mix-down of a multi-channel audio program that includes a center channel.

26. The system in accordance with claim 25, where adjusting the mixing of audio comprises increasing an amplitude of the center channel program to either one of the right or left ears of the listener so as to increase amplitude of the center channel program for the one of the right or left ears of the listener that is moved to a closest location to a source of the directional beams of audio.

27. The system in accordance with claim 24, where the directional beams of audio comprise ultrasonic audio beams.

28. The system in accordance with claim 24, where the image capture device comprises a camera integrated into a television receiver device.

29. The system in accordance with claim 24, where the image capture device comprises a camera integrated into an electronic display device.

30. The system in accordance with claim 24, further comprising at least a pair of gimbal mounted ultrasonic transducer arrays, and where controlling and adjusting the directional beams of audio comprises controlling servo motors that position the gimbal mounted ultrasonic transducer arrays.

31. An audio delivery method, comprising:
at a programmed processor, retrieving and reading a stored listener profile to ascertain audio characteristic settings associated with a listener; and
at an audio mixer, the programmed processor adjusting a mixing of channels of a multiple channel audio program to an equal or reduced number of channels based upon the stored listener profile.

32. The method according to claim 31, further comprising playing the equal or reduced number of channels to the listener.

33. The method according to claim 32, where the programmed processor further adjusts the mixing of the channels based upon a position of the listener.
